(19) United States
(12) Patent Application Publication
(10) Pub. No.: US 2006/0210043 A1
(43) Pub. Date: Sep. 21, 2006

(54) Roll over audio platform

(75) Inventor: John Wade Beam, Chicago, IL (US)

Correspondence Address: BASIL E. DEMEUR, 7369 W. NORTH AVENUE, RIVER FOREST, IL, 60305, US

(73) Assignee: FCI, Inc

(21) Appl. No.: 11/082,029

(22) Filed: Mar. 17, 2005

(51) Int. Cl. H04M 3/42

(52) U.S. Cl. 379/202.01

(57) ABSTRACT

A roll over audio platform designed to be embedded for use within the top of a conference table to display a microphone or other audio means for use on top of the conference table or hide the microphone or other audio means under the conference table when not in use. The platform consists of two main parts: a collar and a support base. The collar has a geometric shape and forms a hollow center. The support base approximates the geometric shape of the collar and is secured within the hollow center of the collar by a hinge. The hinge enables 180° rotation of the support base within the hollow center of the collar. Audio means are mounted to the bottom surface of the support base and the top surface coordinates with the conference tabletop. When not in use the support base is pivoted to a non-use static position the top surface coplanar with the conference table surface. To use the audio means, the support base is pivoted to its use position bringing the audio means to the tabletop surface.

### I. FIELD OF THE INVENTION

The present invention relates to conference tables and, more particularly, to a platform that is imbedded within a conference table to enable unlimited rotation within the conference table to display or hide a microphone or other audio means as desired.

### II. DESCRIPTION OF THE PRIOR ART

Conference tables have become and remain a primary form of equipment in the facilitation of meetings and discussions between groups of business, legal, and/or other entities. Due to the demand and increased versatility, conference tables are designed to accommodate a significant number of individuals for these meetings and discussions. The individuals that attend these meetings and discussions are themselves equipped with hard copy information relevant to the anticipated topics for discussion and, with the advent of the electronic era, are often times equipped with some form of computer equipment whether hand-held, laptop, or some other form.

Yet, with so many individuals at these meetings and discussions and all the information each has available to present to the other individuals at the meeting, one problem continues to plague these meeting and discussions: the individuals at the meetings are unable to naturally speak above the conference noise to be easily heard by all of the individuals that surround the conference table at the meeting.

A number of different inventions have been designed for use in conference tables for such meetings and discussions. However, none of the prior art patents solve the current audio problem presented in the conference meetings.

For example, U.S. Pat. No. 6,028,267 to Byrne entitled “Rotatable Power Center System” discloses a rotatable carriage with a power center system that includes electrical and communication components. The carriage is mounted and housed in furniture assemblies and the like and provides an open and closed position. In the open position, the carriage is rotated at an acute angle to expose the electrical and communication components. The cover of the carriage is provided with a hinge along the center of the cover such that the front and rear portions may rotate relative to each other and thereby permit the exposure of the components. In the closed position, the surface is relatively flat, except for the hinge, with respect to the surface of the furniture assemblies. The cover is also provided with slots to permit the carriage to remain in the closed position while the cords and lines remain energized by the components.

Likewise, U.S. Pat. No. 5,575,668 to Timmerman entitled “Temporary Power/Data Tap” discloses a self-contained unit that is mounted on a pivoting outlet enclosure housed inside an enclosure assembly. The unit is permitted to pivot in relation to the enclosure assembly to reveal the electrical receptacle and data port. The electrical receptacle and data port are disposed in two separate compartments formed in the outlet enclosure. Similarly, U.S. Pat. No. Des 421,961 to Muller entitled “Electrical Receptacle Housing” discloses an electrical receptacle housed within an enclosure.

U.S. Pat. No. 5,709,156 to Gevaert entitled “Flip-Up Electrical And Communications Device For Use In Combination With A Worksurface” illustrates a utility receptacle assembly which includes a base that is mounted to the surface of a workstation, a utility receptacle member to receive and energize electrical and communication components, and a cover. The cover provides a top surface of the device. In the closed position, the cover includes a finger notch to rotate the cover approximately 90° to expose the utility receptacle assembly for use.

U.S. Pat. No. 5,230,552 to Schipper et al. entitled “Worksurface Utilities Module” discloses a module which includes a housing that is pivotally mounted within an aperture in a worksurface. The module includes a top surface that protects and hides the housing. The housing is pivotal between an open position to provide a hollow interior to receive a plurality of utility connector modules and a closed position to substantially hide the retracted receptacle.

U.S. Pat. Nos. Des. 412,698 and Des. 406,102 to Byrne entitled “Large Lift-Up With Cover” and “Double Lift Up Device”, respectively, both disclose a row of electrical and communication components that are housed within a table. The devices are provided with a top cover that blends in with the top surface of the table. The cover includes a slot to lift and expose the row of electrical and communication components in either a vertical or horizontal position. Although the above prior art patents disclose rotatable assemblies to expose electrical and communication components, none of the prior art discloses a roll over audio platform that enables 180° degree rotation to display a microphone or other audio means to solve the audio problem in the conference meeting. Another inherent shortcoming of the prior art patent is that the assemblies do not enable rotation with respect to the conference table to position the assembly on the top of the table in the same manner as if placed on top of the table independent from the conference table. Another inherent shortcoming of the prior art patens is that the assemblies no not efficiently provide the ability to retract and hide the microphone or other audio means for an individual not communicating via the microphone or other audio means during the meeting or when the meeting is not in session. Further, none of the prior art assemblies enable the microphone or other audio means to be automatically activated and de-activated by the mere rotation of the platform. Lastly, the assemblies of the prior art patents do not efficiently permit the microphone or other audio means to be continually activated for use without being disrupted during the unlimited rotation of the assembly with respect to the conference table.

Thus, there is a need, therefore, and there has never been disclosed a platform that is embedded within a conference table and enables activation rotation within that conference table to display or hide a microphone or other audio means as desired and which may be activated or de-activated by rotation of the platform.

### III. OBJECTS OF THE INVENTION

It is the primary object of the present invention to provide a platform that is embedded within a conference table to display a microphone or other audio means. A related object of the present invention is to provide a platform that is capable of hiding the microphone or audio means within the conference table when the microphone or audio means is not being used.

Another object of the present invention is to provide a platform that enables audio activation and de-activation rotation with respect to the conference table to display or hide the microphone or other audio means. A related object of the present invention is to provide a platform that enables rotation with respect to the conference table without disrupting the electrical cords of the microphone or audio means. Another related object of the present invention is to provide a platform that enables the microphone or audio means to be activated during rotation of the platform with respect to the conference table.

Another object of the invention is to provide a platform that is designed to be indistinguishable from the top of the conference table when the microphone or other audio means is not in use.

Still another object of the invention is to provide a platform that is available to all the individuals that surround the conference table at the meeting.

Still another object of the invention is to provide a platform that is safe and easy to use and economical to manufacture.
Other objects of the present invention will become more apparent to persons having ordinary skill in the art of which the present invention pertains from the following description taken in conjunction with the accompanying drawings.

### IV. SUMMARY OF THE INVENTION

The present invention is a roll over audio platform that is designed to be embedded for use within the top of a conference table. The platform consists of two main parts: a collar and a support base. The collar is in a distinct geometric shape and forms a hollow center. The support base approximates the geometric shape of the collar and is secured within the hollow center of the collar by a hinge. The hinge enables the unlimited rotation of the support base within the hollow center of the collar and, thereby, permits the ability of the platform to display a microphone or other audio means for use on top of the conference table or hide the microphone or other audio means under the conference table when not in use.

### V. BRIEF DESCRIPTION OF THE DRAWINGS

The Description of the Preferred Embodiment will be better understood with reference to the following figures:

FIG. 1 is a side perspective view illustrating the roll over platform as embedded within the conference table and corresponding to each of the individuals at the conference table.

FIG. 2 is a perspective view showing the roll over platform having a basically square configuration and pivoted within a square collar and shown in its partially rotated position;

FIG. 3 is a cross sectional view taken along the line 3-3 of FIG. 2 showing the platform in its partially rolled over configuration relative to the collar;

FIG. 4 is a plan view, partially cut away, showing the platform in its static position with the surface of the platform being in conformity with the surface of the tabletop;

FIG. 5 is a plan view, partially cut away, showing the platform in it's rolled over active position relative to the tabletop;

FIG. 6 is a cross sectional view taken along the line 6-6 of FIG. 4 showing the platform in static position relative to the tabletop the audio means concealed relative to the top of the table;

FIG. 7 is a cross sectional view showing the platform in its partially rolled over position incident to moving into its use position;

FIG. 8 is a cross sectional view showing the lock means consisting of a spring loaded ball extending into a central slot to lock the platform into its use and static positions;

FIG. 9 is a cross sectional view showing a spring loaded lock ball in its rolling position incident to the movement of the platform out of the lock position;

FIG. 10 is a cross sectional view showing a spring-loaded ball lock in it's lock position relative to a central slot located in the collar;

FIG. 11 is a plan view partially in cross section, showing the audio means secured to the surface of the platform with the interconnecting wiring located within the central aperture;

FIG. 12 is a plan view, partially in cross section, showing the platform in it's rolled over position relative to the tabletop;

FIG. 13 is a plan view showing the platform in it's rolled over use position relative to the tabletop with an on/off switch positioned within a switch aperture and adapted to control the audio means secured to the platform;

### VI. DETAILED DESCRIPTION OF THE PREFERRED EMBODIMENT

Turning first to FIG. 1, there is illustrated a conference table 10. As a non-limiting example, the conference table 10 is illustrated as being oval in shape. Alternatively, any shape of the conference table 10 is sufficient which includes but is not limited to square, rectangular, circle, triangular, etc. . . . The conference table 10 has a top 12 which is embedded with a plurality of roll over platforms 14. The number of the roll over platforms 14 corresponds to the number of chairs 16 that fits around the exterior circumference of the top 12 of the conference table 10 and is, therefore, a variable number that depends upon the shape of the conference table 10. Preferably, each of the roll over platforms 14 are equally spaced a distance 18 from the exterior circumference of the top 12 of the conference table 10 to form an interior circumference 20 that mirrors the exterior circumference of the top 12 of the conference table 10. In the preferred embodiment and as discussed in further detail below, the distance 18 is sufficient to permit efficient use of the roll over platform 14 by an individual sitting in one of the chairs 16. Preferably, each of the roll over platforms 14 are equally spaced a separation distance 22 from adjacent rollover platforms 14 along the interior circumference 20 formed by the rollover platforms 14.

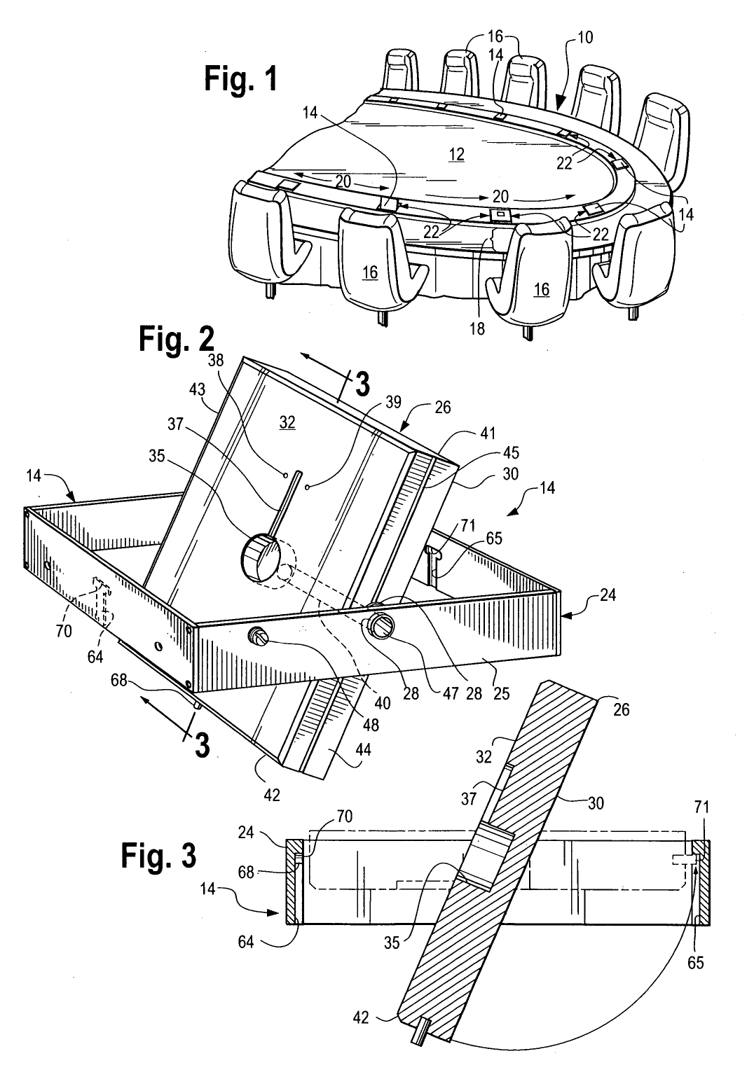

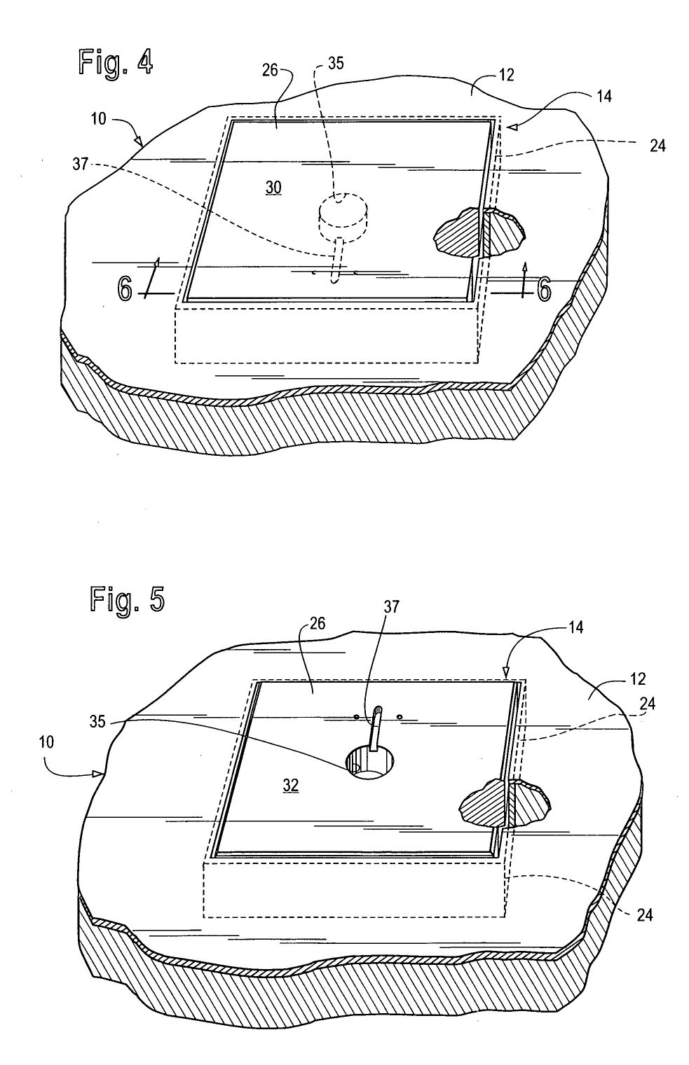

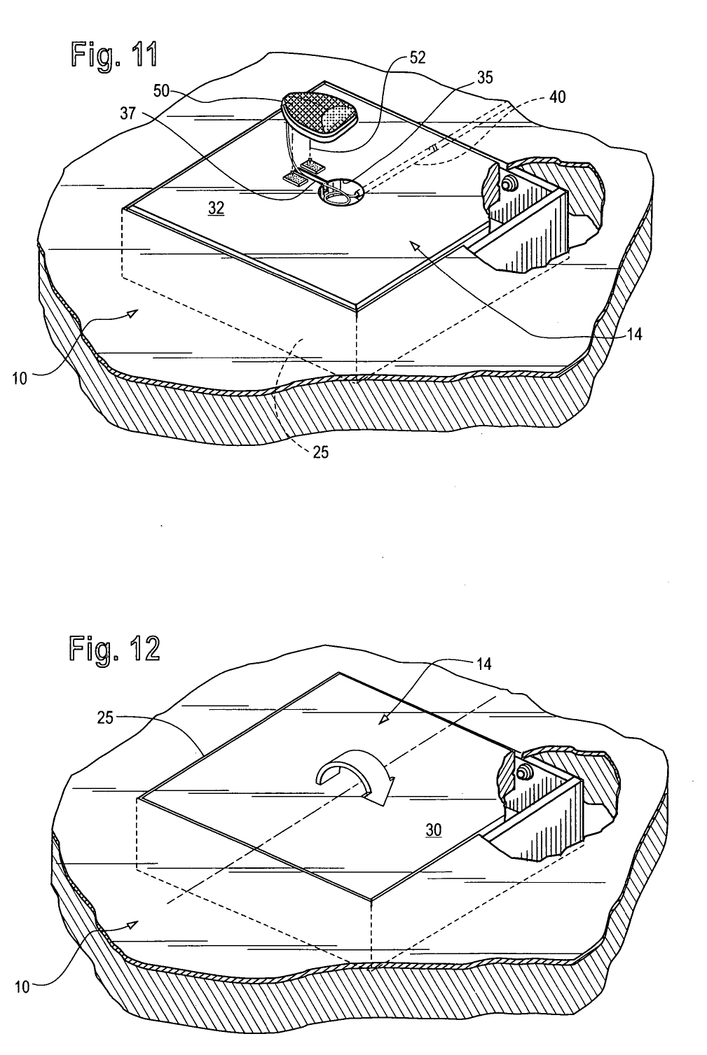

Turning to FIG. 2, the assembly of the roll over platform 14 is more clearly illustrated. Roll over platform assembly 14 comprises a collar 24 and a support base 26. It will be observed that the support base 26 is pivotally secured within the collar 24 by means of a pair of opposed pins 28. The support base 26 is shown to include the top surface 30 and a bottom surface 32. As shown in FIG. 3, the top surface 30 is a flat planar surface, and in completed construction, has a surface which matches with and is coordinated with the composition of the table top surface 12. The bottom surface 32 is shown to include a central aperture 35 from which a lock channel 37 extends outwardly. It will be noted that the central aperture at 35 and lock channel 37 are bored into the bottom surface 32 and do not extend completely through the support base 26 (FIG. 3). FIG. 11 illustrates the manner in which the wiring for the audio device (M is attached to the bottom surface 32 of the support base 26. It will be noted that a lateral bore 40 extends through a portion of the support base 26 and exits through the collar 24 at the point of the pivot pin 28. The opposed pivot pin 28 (not shown) is positioned within a pin aperture having a bushing interposed between the collar wall 24 and the support base 26. The opposed pivot pin is formed by a port tube 29 interposed between a pair of bushings one of which is positioned against the side wall of the collar 24, and the other bushing is positioned against the side wall of the support platform 26. The port tube 29 is constructed to form a connecting joint between the lateral bore 40 and the collar port 47 and further functions as the pivot pin at that position.

As further depicted in FIG. 2, support base 26 is shown to be bounded by opposed forward side walls 41 and 42 and lateral side walls 43 and 44 respectively. The lateral side wall 44 is also provided with a horizontal groove 45 which forms a part of lock means for locking the support base 26 and roll over platform 14 in either the static position or the use position.

FIGS. 2, 8, 9 and 10, illustrate the locking means for disengageably engaging the roll over platform 14 relative to the collar 24. It will be observed that the collar 24 is provided with a spring loaded ball pin 48 which is mounted in the side wall 25 of the collar 24. Mounting may be accomplished by any suitable means such as providing a spring loaded ball pin 48 in the form of a threaded screw which would be mounted through an appropriate aperture in the side wall 25 of collar 24. It will be observed that the spring loaded ball pin 48 extends inwardly from the collar 24 toward the platform and is sized such that as the ball rises in and out of the horizontal groove 45 positioned in the lateral side wall 44 of the support base 26. It's been found that the sizing is important in that the sizing of the ball shound be slightly larger than the depth of the horizontal groove 45 so that the ball pin 48 does not completely ride into the groove 45. Its been found that if the ball pin 48 rides completely into the groove 45, unlocking the support base 26 relative to the collar 24 becomes a more difficult operation. It is therefore deemed to be preferable to make sure that the tension maintained between the spring loaded ball pin 48 and the horizontal groove 45 is sufficient to lock the support base 26 into position relative to the collar 24, but not to the point where to remove it from its lock position requires an excessive amount of force.

FIG. 2 also illustrates that the bottom surface 32 of the support base 26 which provides a place for a mounting of a microphone 50 thereon. The microphone 50 maybe secured to the bottom surface 32 of the platform 14 by any appropriate securement means such as screws or the like. It will be observed that the microphone 50 has its associated wire 52 switch and when the microphone 50 is secured to the bottom surface 32 of platform 14, will lay in the channel 37 then enter the center aperture 35. The reason for the wiring making a loop in the central aperture 35 is to provide strain relief for the microphone. The wire 52 will then extend through the lateral bore 40 and then will run through the appropriate raceway formed in the conference table 10 as described. FIGS. 2 and 11 further illustrate the positioning of the lateral 4 which traverses the support base 26 and extends from the central aperture 35 exiting through the side wall 25 of the collar 24 via the collar port 47. It will therefore be apparent that the wiring 32 associated with the microphone 50 may be freely threaded through the bore 40 exiting through the collar port 47 and will be contained within the appropriate channels located on the underside of the table 10 as previously described. It is known in the art that the conference table 10 may be provided with appropriate raceway channels built into the underside of the table that contain wiring for all electrical and electronic equipment built into the table surface.

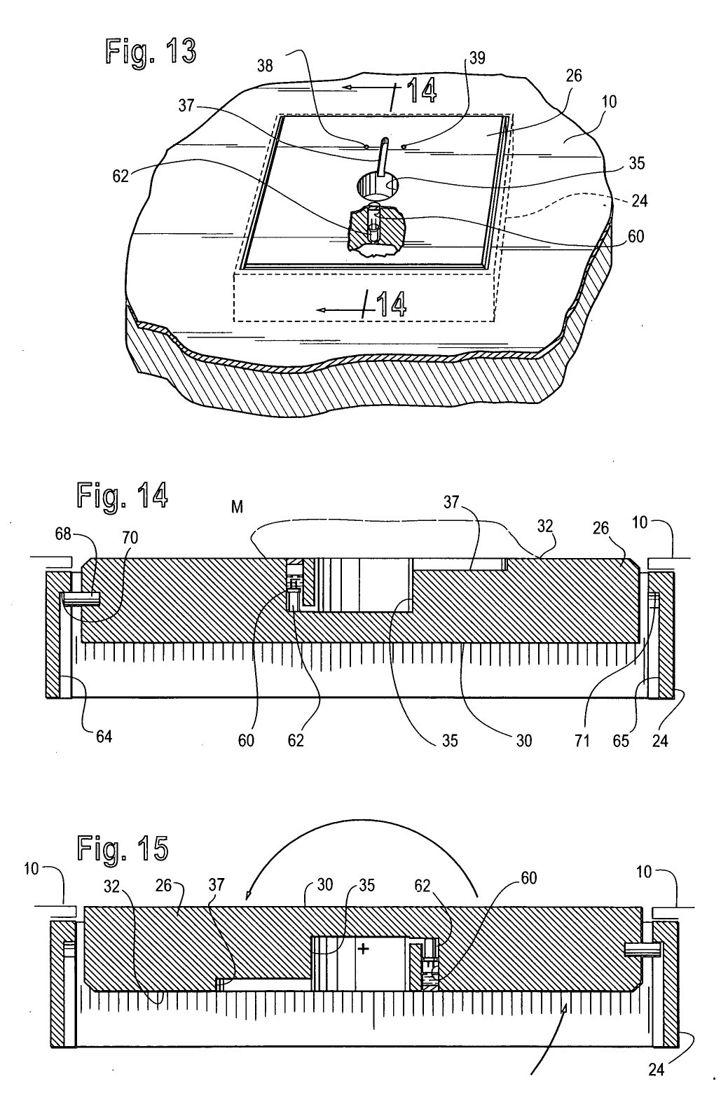

FIGS. 13 through 15 illustrate still a further enhanced embodiment of the present invention. It will be observed that the support platform is provided with an additional switch aperture 60 which accommodates the mounting of a switch 62. A switch 62 may be of any known variety, such as a mercury switch, which is activated and deactivated by the mere rotation of the switch. The switch, as would be known to one skilled in the art, is interconnected with the wiring interconnection 57 and in turn interconnected with the microphone (FIGS. 14 and 15) such that the rotation of the support base 26 relative to the collar 24 from the static position to the use position will activate the switch and thereby activate the microphone. FIGS. 2, 3, 14 and 15 illustrate the further enhancement of the present invention in that the support base 26 and collar 24 incorporate the stop means for stopping the support base in its use or static position. With particular reference to FIG. 13, will be observed that the collar 24 is provided with a pair with opposed stop channels 64 and 65 respectively while the support base 26 is provided with a stop pin 68. Each of the stop channels 64 and 65 are sized to accommodate the movement of the stop pin 68 therein until the stop pin 68 abuts against a stop flange 70 and 71 respectively. The length of each of the stop channels 64 and 65 and the positioning of the stop flanges 70 and 71 are coordinated with the spring loaded ball pin 48 and the horizontal groove 45 such that once the support base 26 is rotated to either the static position or the use position, such that the ball pin 48 rides into the horizontal groove 45, the stop pin 68 will reach and abut against the appropriate stop flange 70 or 71 respectively. Hence, the stop pin 68 and appropriate stop channels 64 and 65 and stop flanges 70 and 71 cooperate with the positioning of the spring loaded ball pin 48 riding into the horizontal groove 45 to accommodate the locking of the support base 26 in either the static or the use position as desired by the operator but will come to rest in horizontal alignment onto the table surface. In FIG. 14, the support base 26 is shown to be in the use position relative to the support collar 24 and the microphone M (shown in phantom) is positioned on the top of the table 10. FIG. 15 illustrates a support base 26 in its rotated static position with the microphone shown positioned underneath the table 10 having the top surface 30 of the support base 26 in alignment with the top of the table 10.

In the preferred embodiment of the invention, each of the pivot pins 28 is provided with the appropriate bushings interposed between the collar 24 and support base 26 to facilitate the ease of rotation and avoid any friction incident to the rotational movement of the support base 26 relative to the collar 24. In addition, it is desirable to size the diametric dimension of the lateral bore 40 to be slightly oversized relative to the wiring interconnection 57 which allows for additional wiring to be inserted therethrough. In this manner, it is contemplated and anticipated that as technology advances, and additional new types of audio devices become available, the microphone M may be switched out to new equipment, or indeed, new equipment may be added with the wiring accommodated through the lateral bore 40 without having to reconstruct the table 10, or to reconstruct each of the support roll over platforms 14. It is anticipated that the roll over platform assembly 14 including the collar 24 and support base 26 are permanently secured and embedded within the confines of the table 10, and therefore same can only be removed with great difficulty. Hence, to avoid such a problem, lateral bore 40 is constructed oversized relative to the wiring interconnection 57 in order to accommodate new technology and or additional wiring.

It is further contemplated that the particular geometric shape of the support roll over platform 14 may assume any desired shape. As illustrated in the drawings, the roll over platform assembly 14 is shown to be in a square or a rectangular configuration. However, circular configurations work equally well. Other geometric shapes are feasible. It is contemplated that the particular geometric configuration of the roll over platform assembly 14 is dictated by the design characteristics of the table 10 and hence may assume any geometric shape so long as the parameters of the present invention are maintained including the provision of pivot pins 28 to allow rotational movement of the support base and especially the ability to install a lateral bore through the support base.

It will also be apparent by the above description that the lateral bore 40 which exits into the collar 47 will function as the pivot pin on that particular side of the support base. It will therefore be appreciated that the support base 26 is freely rotatable relative to the collar 24 without twisting or entangling the wiring interconnection 57 as the support base 26 is rotated to either the static or the use position.

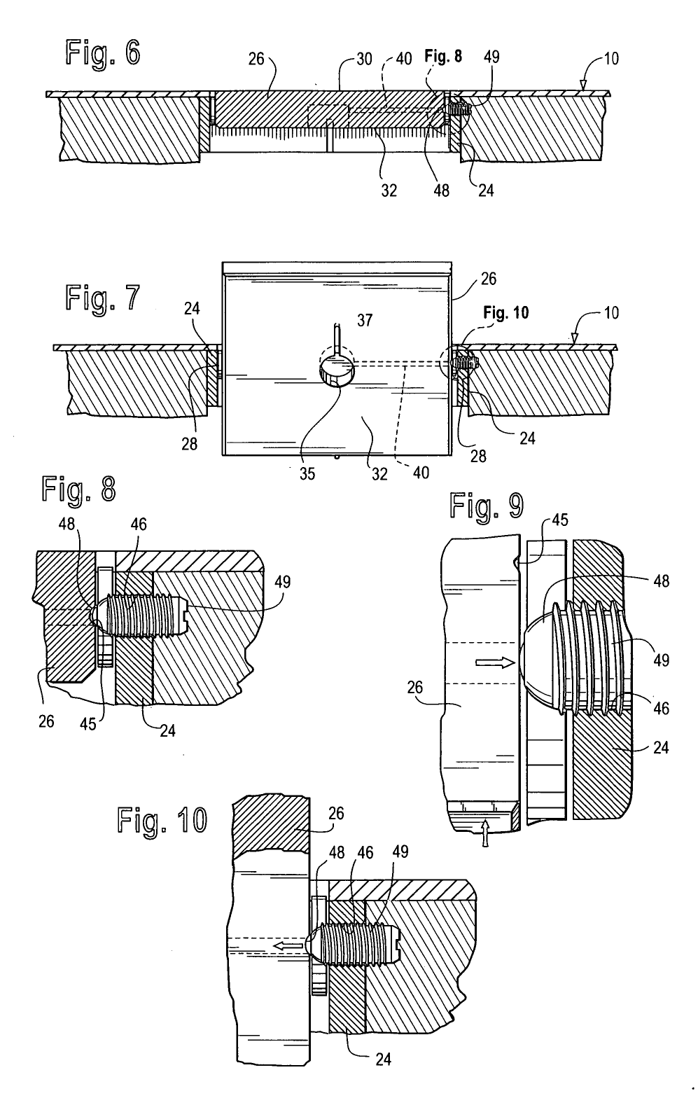

As depicted in FIGS. 6 through 10, the spring loaded ball pin 48 will take the form of a screw threaded pin 49 which is screwed threaded through a threaded port 46 positioned in one of the side walls of the collar 24. In this manner, the positioning of the spring loaded ball pin 48 relative to the horizontal groove 45 may be adjusted during the manufacture in order to accommodate positive locking interrelationship between the parts without having the same being too tight and cause the support base 26 to bind relative to the collar 24. Furthermore, by providing the spring loaded ball pin 48 in the format of the screw threaded pin, the screw threading of the spring loaded ball pin 48 may be adjusted if necessary, even after the entire conference table 10 is manufactured.

In use then, the roll over platform assembly 14 is rotated from its static nonuse position to the use position to enable the use of the microphone M or other audio means by an individual at the table 10. When the use of the microphone or other audio means is no longer desired, the roll over platform assembly 14 is rotated from the use position back to the non-use static position to remove the microphone or other audio means from visibility and to retain the microphone or other audio means for subsequent later use. The on/off switch will cause the microphone M or any other audio means to be turned off when inverted to the static position. In the static position, the top surface 30 of the support base 26 is now co-planer with the conference table top 10 and maintains the style and design of the conference table virtually hiding the microphone from visibility maintaining a level surface for the entire conference table. Hence, any unique design features associated with the table 10 are preserved when the microphone or any audio means is not in use. Further, since the roll over platform assembly 14 is provided with a spring loaded ball pin a locking means, once the roll over platform 14 is positioned in its static position, it locks in to the static position and is held in place such that any person utilizing the conference table 10 may actually work on the surface over the support platform 14 without causing the support platform 14 to commence rotation. The operator need only apply sufficient manual pressure to the platform to unlock the ball pin 48 from the horizontal groove 45 in order to rotate the same for the use of position.

Thus there is been provided a roll over platform assembly to affectively provide microphone or other audio means to an individual at a conference table. While the invention has been described in conjunction with the specific embodiment and geometric shape, it is apparent that many alternatives, modifications, and variations will be apparent to those skilled in the art in light of the foregoing description. Accordingly, it is intended to cover all such alternatives, modifications, and variations in the appended claims.

1. A rollover platform assembly for alternately displaying and hiding audio means adapted to be constructed within a table surface, comprising,
a collar having a predetermined geometric shape, and being mounted in said table surface,
a support base pivotally mounted within said collar by a pair of opposed pivot pins and being rotatable therein, said support base bounded by continuous side walls,
said support base having a predetermined geometric shape conforming to said geometric shape of said collar,
said support base having a top surface which when rotated to a static position is coplanar with table surface, and a bottom surface which may be rotated to a use position,
said bottom surface provided with a central aperture,
audio means mounted on said bottom surface and provided with wiring interconnections associated therewith and contained within said aperture,
said support base provided with a lateral bore extending from said central aperture and exiting through a portion of said sidewall of said support base,
said collar having a collar port in registry with said lateral bore to accommodate the wiring interconnections to pass through said lateral bore and collar port thereby to permit the free rotational movement of said support base relative to said collar without causing a binding of said wiring interconnections incident to the rotation of said support base,
and locking means for alternate locking said support base in the static and in the use position,
whereby said support base may be rotated from a static non-use position presenting the top surface in coplanar relationship with the table surface to an inverted position presenting the audio means on the bottom surface in relative coplanar relationship with the table surface.

2. The improved rollover platform assembly as set forth in claim 1, wherein said support base is provided with one pivot pin journaled within a pivot aperture in said collar and the opposed pivot pin being formed as a port tube interposed between said support base lateral bore and said collar port thereby to allow the free rotational movement of said support base relative to said collar while providing an exit port for said wiring interconnections.

3. The improved rollover platform assembly as set forth in claim 2 above wherein each of said pivot pins is provided with bushings interposed between said support base and said collar to facilitate the rotational movement of said support base relative to said collar and minimize any friction during rotation.

4. The improved rollover platform assembly as set forth in claim 1 above wherein said locking means comprises a horizontal groove formed along a side wall portion of said support base, and a spring-loaded ball pin mounted in said collar and positioned to ride into and out of registry with said horizontal groove, and further positioned to effect the locking of said support base relative to said collar when said support base is in horizontal alignment with said table surface.

5. The improved rollover platform assembly as set forth in claim 4 above, wherein said spring-loaded ball pin is sized relative to said horizontal groove such that said ball pin only rides partially into said horizontal groove thereby to affect the locking of said support base to said collar while avoiding a binding locking relationship.

6. The improved rollover platform assembly as set forth in claim 1 above, wherein said platform assembly is provided with stop means for stopping the rotational movement of said support base relative to said collar when said support base is in horizontal alignment with said collar and table surface, said stop means form a stop pin mounted on the side wall of said support base, and a pair of opposed stop channels formed in said collar, each of said stop channels provided with a stop flange which arrests the movement of said stop pin when said stop pin abuts said stop flange, said stop flange and stop pin being positioned to stop the rotational movement of said support base when said support base is in horizontal alignment with said collar and table surface.

7. The improved rollover platform assembly as set forth in claim 4 above, wherein said platform assembly is further provided with stop means constructed to be in coordination with said locking means such that said stop pins will function to stop the rotational movement of said support base relative to said collar and table surface when said spring-loaded ball pin rides into said horizontal groove thereby locking said support base relative to said collar and stopping the support base only when said support base is in horizontal alignment with said collar and table surface.

8. The improved rollover platform assembly as set forth in claim 1 above, wherein said support base is further provided with a switch aperture positioned adjacent said central aperture, switch means mounted within said switch aperture and interconnected with said audio means, said switch means being actuated between an on position and an off position by rotational movement of said support base whereby the rotational movement of said support base into the static position causes said switch means to go to the off position and turn off said audio means, and the rotational movement of said support base to the use position causes the switch means to go to the on position and turn on said audio means.

9. The improved rollover platform assembly as set forth in claim 9 above wherein said switch means comprises a mercury switch which is in the off mode in the upright position and is in the on mode when in the inverted position.

10. A improved rollover platform assembly for alternately displaying and hiding audio means constructed within a table surface comprising,
a collar having a predetermined geometric shape, and mounted in said table surface,
a support base pivotally mounted within said collar by a pair of opposed pivot pins and being rotatable therein, said support base bounded by continuous side walls,
said support base having a predetermined geometric shape conforming to said geometric shape of said collar,
said support base having a top surface which when rotated to the static position is coplanar with the table surface and a bottom surface which may be rotated to a use position,
said bottom surface provided with a central aperture,
audio means mounted on said bottom surface and provided with wiring interconnections associated therewith and contained within said aperture,
said support base provided with a lateral bore extending from said central aperture and exiting through a portion of said side wall and positioned to form one of said pivot pins,
said collar having a collar port in registry with said lateral bore to accommodate the wiring interconnections to pass through said lateral bore and collar port thereby to permit the free rotational movement of said support base relative to said collar, without causing a binding of said wiring interconnections incident to the rotation of said support base,
and locking means for alternately locking said support base of the static position and in the use position,
said locking means formed by a horizontal groove formed along a sidewall portion of said support base, in a spring-loaded ball pin mounted in said collar and positioned to ride into and out of registry with said horizontal groove and further positioned to effect the locking of said support base relative to said collar when said support base is in horizontal alignment with said table surface.

11. The improved rollover platform assembly as set forth in claim 1 above, wherein said collar is in a square configuration, and said support base is also in a square configuration, said support base being sized in order to fit within the confines of said collar.

12. The improved rollover platform assembly as set forth in claim 1 above, wherein said collar is circular in configuration, and said support base is circular in configuration and sized to fit within the confines of said circular collar.

13. A method for concealing an audio device within the confines of a table surface comprising the steps of,
providing at least one collar having a predetermined geometric shape, said collar being adapted to the positioned in a table surface,
providing a support base pivotally mounted within the confines of said collar by a pair of opposed pivot pins such that said support base is rotatable therein, the support base being bounded be continuous side walls,
providing said support base with a predetermined geometric shape conforming to the geometric shape of said collar,
providing said support base with a top surface which when rotated to the static position is coplanar with the table surface, and a bottom surface which may be rotated to a use position,
providing said bottom surface with a central aperture,
providing audio means for mounting on the bottom surface of said support base and provided with wiring interconnections associated therewith and contained within said central aperture,
providing said support base with a lateral bore extending from said central aperture and exiting through a portion of the side wall thereof,
providing the collar with a collar port in registry with the lateral bore to accommodate the wiring interconnections to pass through said lateral bore and collar port thereby to permit the free rotational movement of said support base relative to the collar without causing a binding of said wiring interconnections incident to the rotation of said support base providing said collar port with a collar port tube for interconnecting said lateral bore with said collar part and said port tube functioning as the opposed pivot pin,
and providing locking means for alternately locking said support base in the static position and in the use position,
whereby the audio means may be alternately exposed for use and concealed from view depending upon the rotational movement of the support platform upon which said audio means is mounted.

14. The method as set forth in claim 14 above, wherein said method further includes the step for providing switch means in electrical communication with said audio means and positioned within said central aperture, said switch means being actuated between and on position and an off position by the rotational movement of said support base whereby the rotational movement of said support base into a static position causes the switch means to go to the off position and turn off the audio means and the rotational movement of said support base to the use position causes the switch means to go to the on position and turn on said audio means.

| | |
|---|---|
| 00 | |
| 01 | |
| 02 | |
| 03 | |
| 04 | |
| 05 | |
| 06 | |
| 07 | |
| 08 | |
| 09 | M-Audio Device |
| 10 | Conference Table |
| 11 | |
| 12 | Tap |
| 13 | |
| 14 | Rollover Platform |
| 15 | |
| 16 | Chairs |
| 17 | |
| 18 | Spared Distance |
| 19 | |
| 20 | Interior Circumference |
| 21 | |
| 22 | |
| 23 | |
| 24 | Collar |
| 25 | Sidewall of 24 |
| 26 | Support Base |
| 27 | |
| 28 | Pins |
| 29 | Port Tube |
| 30 | Top Surface |
| 31 | |
| 32 | Bottom Surface |
| 33 | |
| 34 | |
| 35 | Central Aperture |
| 36 | |
| 37 | Channel |
| 38 | Mounting Aperture |
| 39 | Mounting Aperture |
| 40 | Lateral Bore |
| 41 | Forward Side walls |
| 42 | Forward Side walls |
| 43 | Lateral Side walls |
| 44 | Lateral Side walls |
| 45 | Horizontal Groove |
| 46 | Threaded Port |
| 47 | Collar Port |
| 48 | Spring-Loaded Ball Pin |
| 49 | Screw Threaded Pin |
| 50 | Microphone |
| 51 | |
| 52 | Associated Wire |
| 53 | |
| 54 | |
| 55 | |
| 56 | |
| 57 | |
| 58 | |
| 59 | |
| 60 | Switch Aperture |
| 61 | |
| 62 | On/Off Switch |
| 63 | |
| 64 | Stop Channel |
| 65 | Stop Channel |
| 66 | |
| 67 | |
| 68 | Stop Pin |
| 69 | |
| 70 | Stop Flange |
| 71 | Stop Flange |
| 72 | |
| 73 | |
| 74 | |
| 75 | |
| 76 | |
| 77 | |
| 78 | |
| 79 | |
| 80 | |
| 81 | |
| 82 | |
| 83 | |
| 84 | |
| 85 | |
| 86 | |
| 87 | |
| 88 | |
| 89 | |
| 90 | |
| 91 | |
| 92 | |
| 93 | |
| 94 | |
| 95 | |
| 96 | |
| 97 | |
| 98 | |
| 99 | |
